(19) United States
(12) Patent Application Publication
(10) Pub. No.: US 2018/0111229 A1
(43) Pub. Date: Apr. 26, 2018

(54) Modular Parts Loading and Unloading System

(71) Applicant: Amada America, Inc., Buena Park, CA (US)

(72) Inventors: Michael Beransky, Irvine, CA (US); Mihai Cioclei, Chino Hills, CA (US); Alexey Volovik, Anaheim, CA (US); Jonas Gutierrez, Whittier, CA (US); Fred Cortez, Downey, CA (US); Karapet Kirishchyan, Chino, CA (US)

(73) Assignee: Amada America, Inc., Buena Park, CA (US)

(21) Appl. No.: 15/299,136

(22) Filed: Oct. 20, 2016

(51) Int. Cl. B23K 26/38; B23K 26/70; G05B 19/042

(52) U.S. Cl. CPC B23K 26/38; G05B 2219/23389; G05B 19/0421; B23K 26/702

(57) ABSTRACT

A basic loading and unloading system comprising a laser, shuttle, and controller, a module being added to the system in a manner whereby neither the laser, shuttle or controller needs to be physically modified.

### BACKGROUND OF THE INVENTION

### 1. Field of the Invention

The present invention provides a cycle loader in modular form that can be incorporated into most parts processing systems.

### 2. Description of the Prior Art

Systems for providing structural support for a particular application, such as a shuttle system, are generally constructed of a variety of components. These components are used to form the shuttle chords and lattice frames, for example. Therefore, in order to form a section of a shuttle frame, various pieces of materials typically need to be cut to size and welded together to form the frame section. The process for forming a section of a shuttle frame is labor intensive and, once assembled, still requires machine work (drilling, etc.) in order to accommodate the shuttle accessories. Once the complete frame structure is built for a specific application, there is little flexibility to the design in order to allow for changes in the width or overall length of the support structure.

There is a need for a method to easily and inexpensively modify/customize existing part processing systems and that can be easily transported and quickly and easily assembled/disassembled whether it be on site or in a more remote location in the field.

U.S. Pat. No. 8,925,718 to Miles, et al, discloses one approach to solving the problem noted above. In particular, a modular support system having individual frame modules each of which is formed by a series of standardized components that are secured together to form a generally elongate support structure for various uses, in particular, a support structure for a shuttle. A truss frame module and a channel frame module are disclosed wherein both of the frame modules include a pair of elongate side frame members that are laterally spaced-apart and generally parallel, these frame members being secured together by a series of laterally-extending and transverse frame members. Specialized connectors attach to the ends of the laterally-extending and transverse frame members, which in turn are secured to the frame members. The component of each of the frame modules are substantially identical to the other so that they can be inverted or reversed without affecting assembly of the frame.

Although the '718 patent describes one technique for modifying the width and length of a parts cutting system, mechanical intervention is still required to either separate joined components or to assemble separate components to form an integral parts processing system.

What is derived is to provide a parts processing system wherein modular units can be added to a base, or main, unit using electronic and mechanical means and without making significant physical adjustments thus reducing the cost of modifying existing parts processing apparatus such as a laser based parts cutting system.

### SUMMARY OF THE INVENTION

The present invention provides a novel technique for adding modules to a computer (controller) controlled existing shuttle based system, such as a laser material cutting system. The modular add-on is configured to communicate with the controller so that when the module is positioned adjacent an original system component it is recognized by the controller and allows a human operator to input various commands to adjust the parameters of the combined system so that it operates as desired. In essence, the system of the present invention enables a user the flexibility of adding a module to the basic system which is automatically recognized; automatic recognition of the added module being accomplished by having the controller is accomplished by having the network detect a unique I/O address on the module. Subsequent to detection, a message appears on the controller screen, the operator then having the option of selecting a default configuration of the added module or a customized one.

The system of the present invention uses standard industrial networks, such as Ethernet/IP and EtherCAT. The controller used in the present invention is programmed with Omron's Network Configurator for Ethernet/IP (software used to graphically build, set and manage Ethernet/IP networks) and Sysmac Studio (the headquarters of OMRON Corporation is located in Kyoto, Japan). The controller has a predefined network and periodically checks for connected modules. Whenever a new module is connected, the controller turns on a flag indicating a newly detected module and after the user's acceptance, communication is established between the controller and the new module.

### DESCRIPTION OF THE DRAWINGS

For a better understanding of the present invention as well as other objects and further features thereof, reference is made to the following description which is to be read in conjunction withe the accompanying drawing therein:

FIG. 1 is a simplified block diagram of the present invention;

FIGS. 2(a)-1)c) illustrate the basic system with different modules added thereto;

FIGS. 3 and 4 illustrate module connections the base system.

FIG. 5 illustrates in more detail how a slave module can be positioned with respect to the master module in either the front or rear loading positions; and:

FIG. 6 is a flowchart illustrating how a connection is established with newly added modules.

### DESCRIPTION OF THE INVENTION

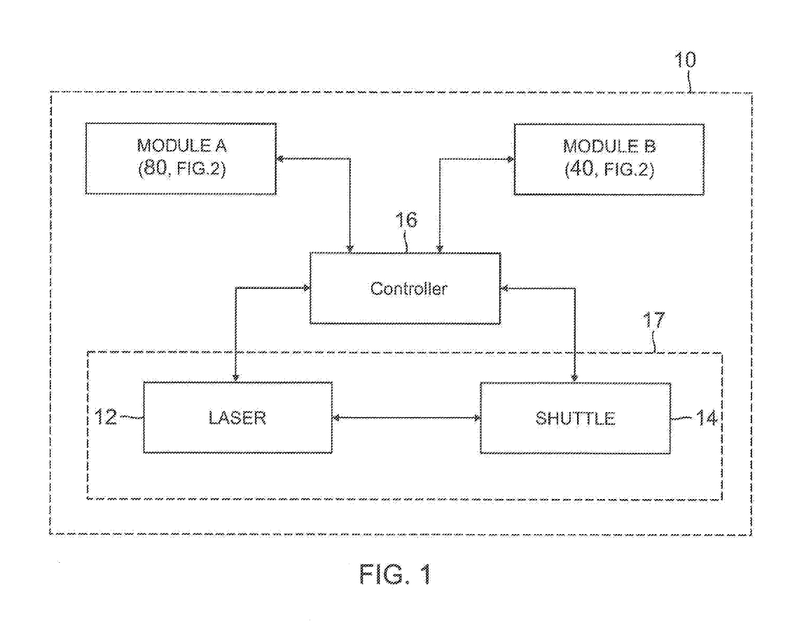

FIG. 1 illustrates a simplified block diagram of the automated main system 10 of the present invention. System 10 comprises laser 12, shuttle 14 and controller, or computer, 16 (note that laser 12 and shuttle 14 form the basis of a stand-alone laser cutting system 17.

In accordance with the teachings of the present invention, a customer that has already purchased the main system 17 can upgrade and enhance that system rapidly and inexpensively by adding modifies A and B thereto (module A, for example, can be a master module and module B can be a slave module).

As illustrated, controller 16 interacts with, and controls, the various components which comprise system 10.

As will be set forth in more detail hereinafter, once a particular module is selected, it is positioned adjacent to main system 17 and cables are utilized to connect the that module to controller 16, thereby automatically establishing communication between those components (note that in lieu of cables, a wireless connection can utilized). Once connected and recognized, the module parameters are automatically set to established default values and the module is then ready to be operated. If additional modules are to be added to the above configuration (i.e. module B), default values that have already been assigned to the added module is automatically configured upon connection and recognition.

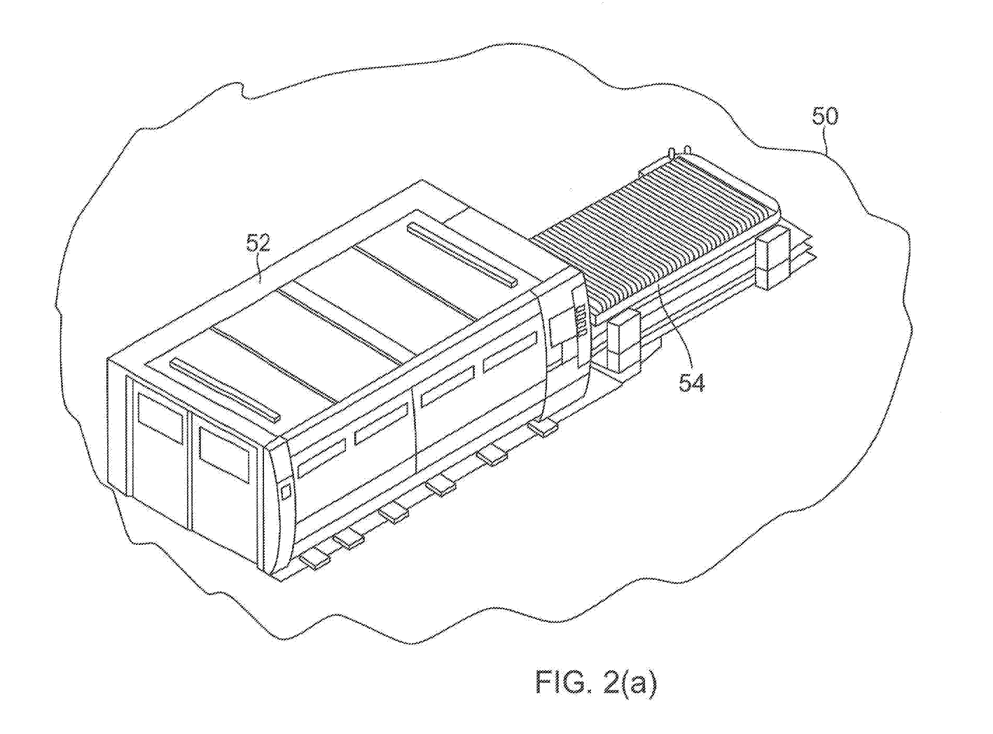

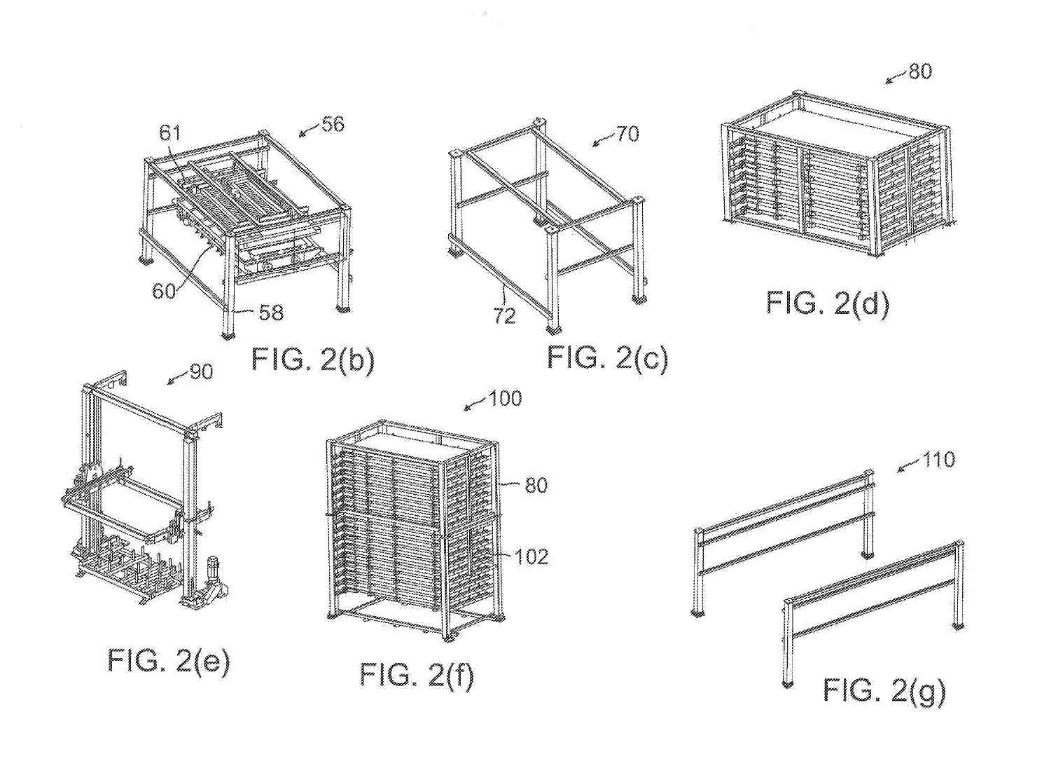

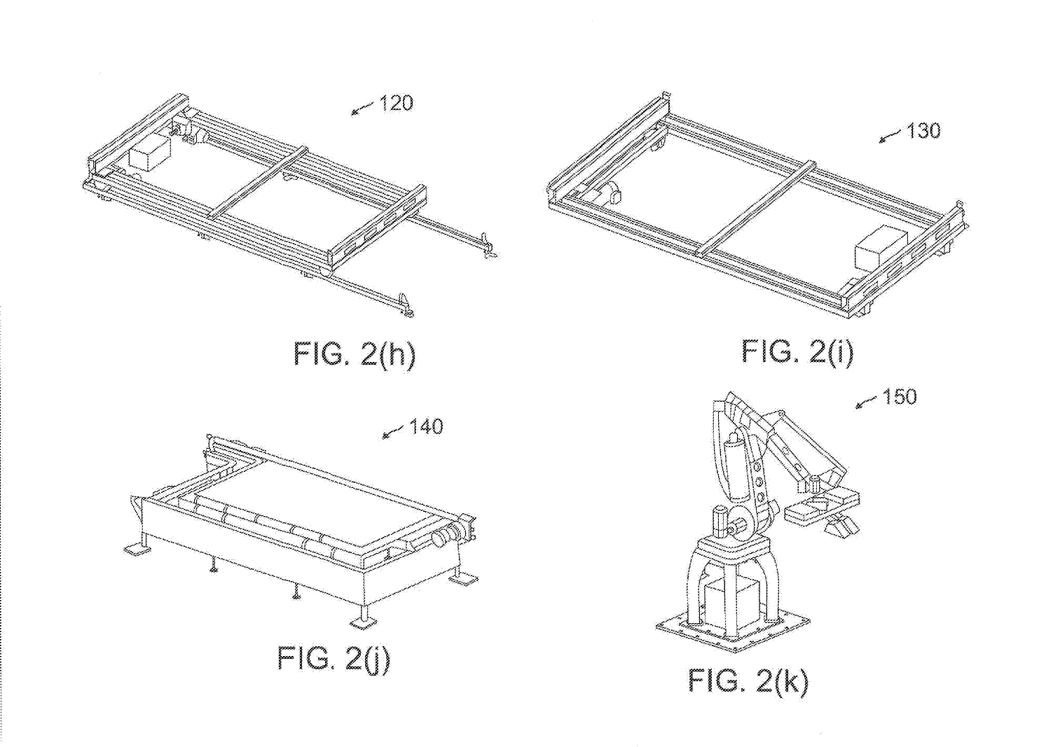

Referring now to FIGS. 2A-2C, a simplified diagram illustrating the concept of the modular system of the present invention when utilized, for example, in a laser cutting apparatus is illustrated.

FIG. 2A shows the components forming the basic laser cutting apparatus 50. In particular, apparatus 50 comprises laser 52 and shuttle 54.

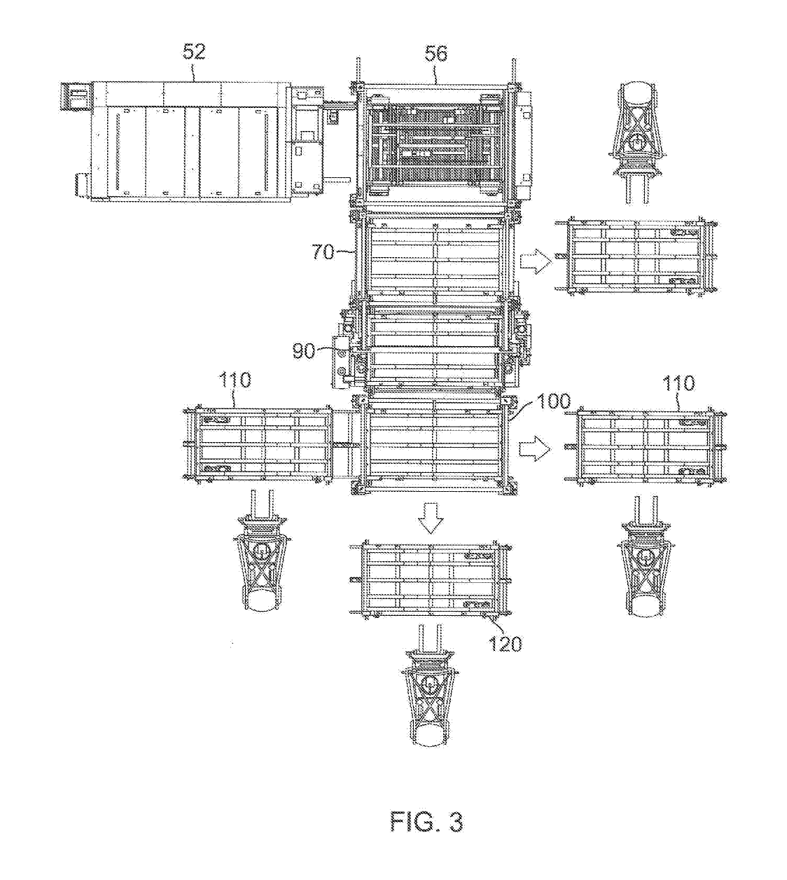

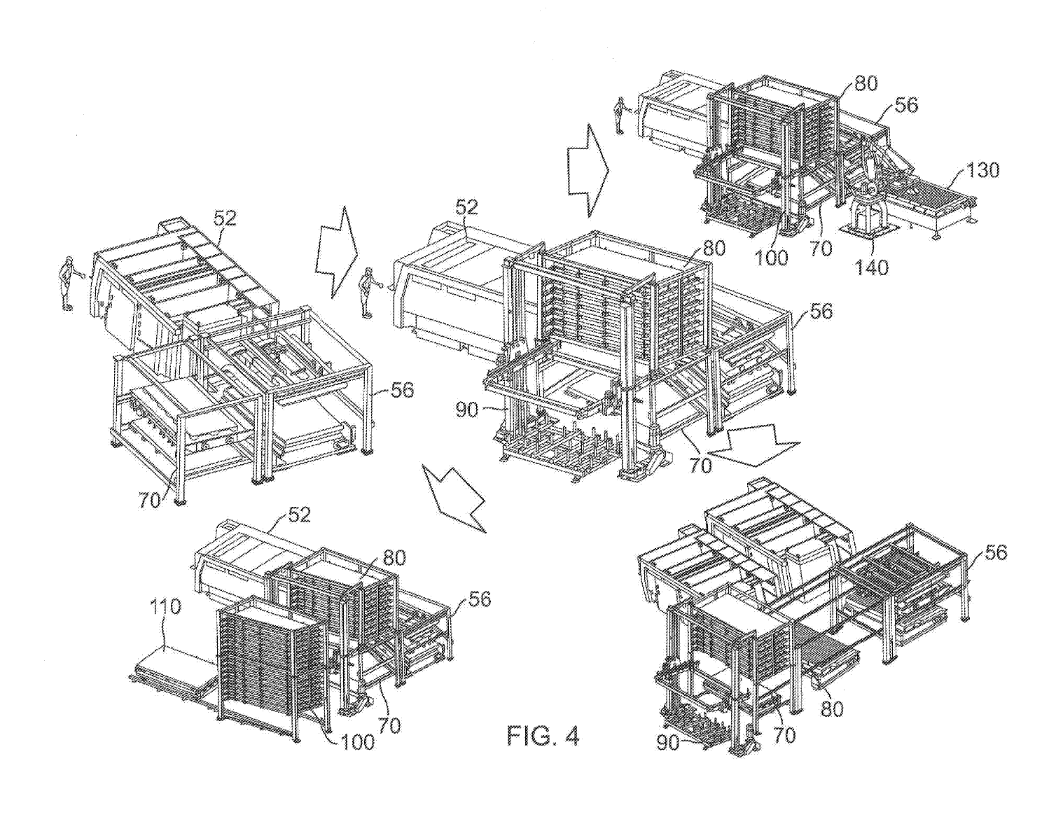

FIGS. 2B and 2C illustrate a number of modules that can be operatively connected to apparatus 50 using the teachings of the present invention. The first module 56 is referred to as the master module. The master module 56 comprises a support frame 58 and loading unit 60 and unloading unit 61. The second module 70, referred to as a slave module, comprises a frame 72. The third module 80, referred to as a top tower module, stores a plurality of material sheets. The fourth module 90, referred to as a crane module, functions to load (or unload) material sheets from the top tower module 80. The fifth module 100 is a twin tower consisting of top tower 80 and bottom tower 103; the sixth module 110 is an insert which allows a second laser to be connected to the basic system; the seventh module 120 is designated as moving CART-X to deliver material to the tower; the eighth module 130, designated as moving CART Y to deliver material to the tower; the ninth module 140 is a second output station for manually unloading cut parts; and tenth module 140 sorts cut parts exiting the laser cutter. FIGS. 3 and 4 illustrates the installation of different modules in relation to cutting apparatus 50.

The process for establishing communications with an added module is shown in FIG. 4. Specifically, the controller being operational (step 50) then determines whether a new module has been connected to the controller (step 52). If not (lead 54) the controller is configured to wait for a new module to be connected. If a new module is recognized (connected), an icon corresponding to that module is displayed on the controller screen (step 56). The human operator or then either assigns default parameters to the module (step 58) or customized parameters (step 60). If default parameters are to be added, the connected module is established with the selected default parameters (step 62) which the main module is made aware of via reference lead 64. If customized parameters are selected (step 66), the customized parameters are relayed to the main module via reference lead 64.

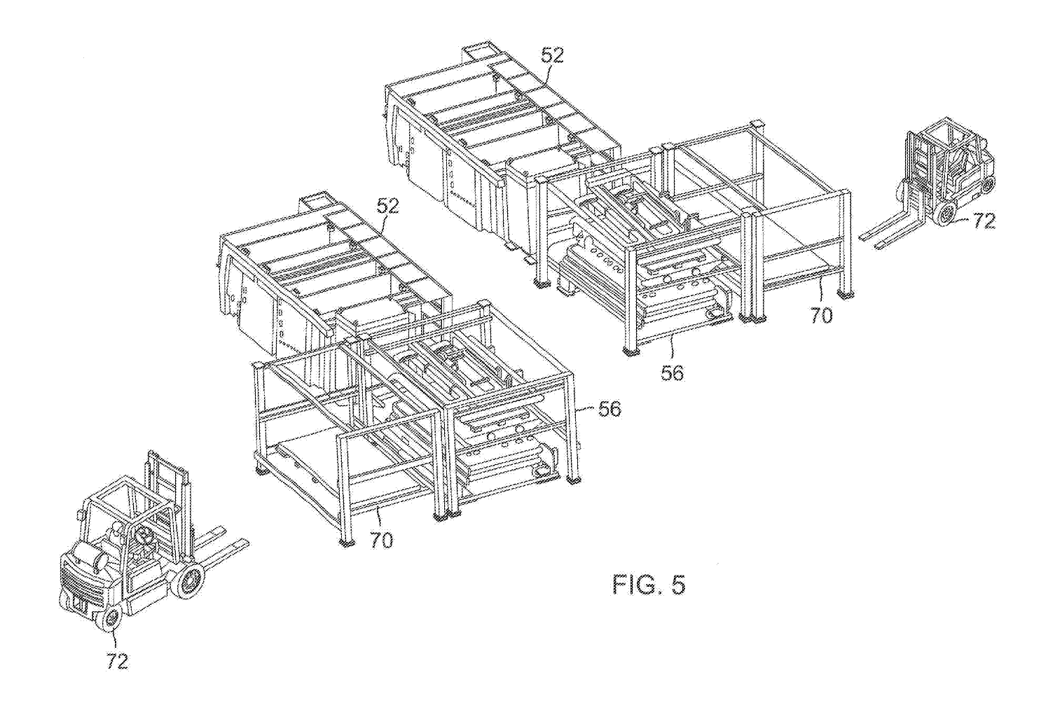

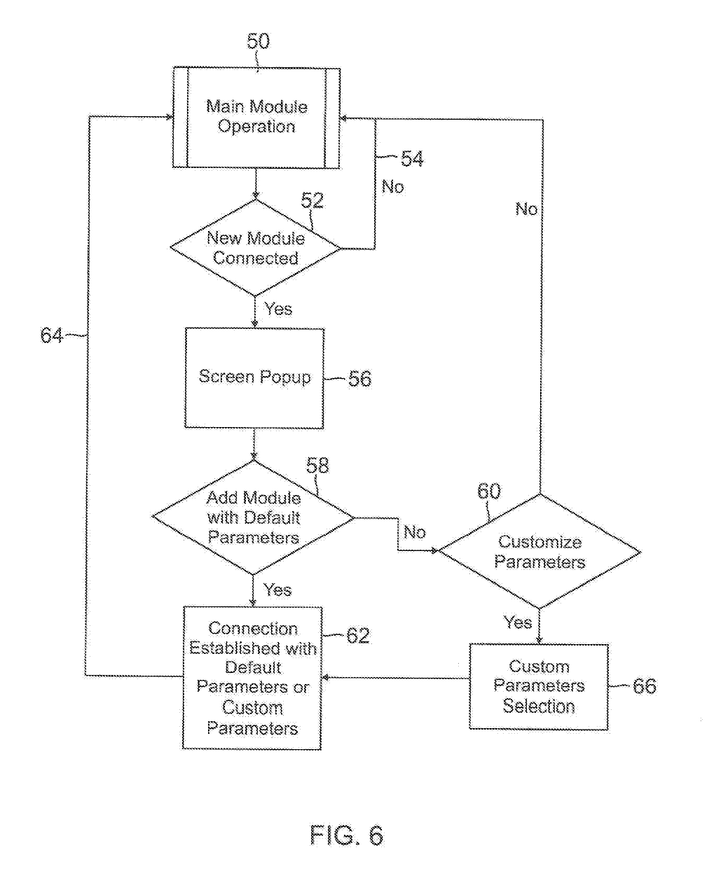

FIGS. 5(a) and 5(b) illustrate in greater detail the positioning of the slave module adjacent the master module for front loading of sheet material and for rear loading, respectively. Communication is first established between the connected devices (in the illustration, slave module 70 is in communication with the controller) and the devices function according to the configuration selected by the controller operator. The controller periodically checks for any other predetermined modules that are not also connected to the laser cutting system. Once a module is connected, the controller initializes communication to the newly added module.

The fork unit 72 initially moves the slave module 70 adjacent master module 56 within a predetermined distance thereof to load material and unload parts. Then the operator connects communication cables that connect the slave module 70 to controller 16 (FIG. 1). Controller 16 thereafter configures slave module 70 such that it is capable of receiving material delivered by fork unit 72. At this point, the slave module 70 is incorporated into system 10 and the overall cutting operation is now ready to proceed. Specifically, the transport unit, or shuttle 75, associated with master module 56, unloads material from slave module 70 and delivers it so shuttle 54. Shuttle 54, in turn, is programmed to deliver the sheet material to laser 52 whereat the sheet material is cut into the desired size and shape.

Alter the user accepts the newly added module, the connection is finalized and the module a ready to be used with the system.

The steps utilized to establish the connection of the new module (such as the slave module) to the controller as follows:

1. The module is spaced placed a predetermined position from the controller;

2. The module is attached to the controller using air lines, and communication (Ethercat and/or Ethernet) cables. Electrical power (480 v) can be applied to the controller or separate power brought to the module depending on system power requirements.

3. After the controller and module are connected together, the communication interface selected enables the controller to communicate with main module 50. If it is Ethercat, controller portion of the system is configured with all Ethercat nodes, the nodes being disabled. Once the proper module is attached, using Sysmac software developed by OMRON the installer will forward the module node address to the controller. By doing so, the controller now recognizes the module and provides a list of parameters to configure the module in a predetermined manner.

In this case of Ethernet IP, a general list determines which IP address the module will use and a data exchange is configured in the controller so that the controller can talk to the module via Ethernet IP (Ethernet communication protocol). Once this data is shared between the controller 16 and the module, a list of parameters will be activated in a manner to configure the module.

4. The controller 16 has a place in memory so store the Ethernet IP address, and all Ethercat node configurations. The Ethernet/IP data exchange information is also stored in controller 16, all the configurations being stored in a file using the Sysmac studio software.

5. Once the controller knows the existence of the module, the HMI (human operator interface) enables hidden parameters that determine how the controller interacts with the module (all these parameters are stored in non-volatile memory). These parameters also will be able to export to a text file into a storage device or flash drive card for backup purposes.

Note that each module that will be attached to the controller has a unique ID number. Use ID number contains a unique Ethercat node number and/or Ethernet IP address.

A controller which has been successfully utilized in the system of the present invention is the Omron NJ series controller.

The default parameters are divided into types; the first type determine the minimum configuration of the system (no devices added), which will be populated by Ethercat or Ethernet IP flags. The second type of parameters are the ones that determine the positioning speed and height of the material loading unit and the part unloading unit and in which direction the material loading unit moves.

The custom parameters are unique to the module added and how they interact with the MU base controller. A second laser can be configured as an added module if required.

The present invention thus provides a flexible and adaptable technique for adding modules to a basic loading and unloading system, such as the laser cutting system noted hereinabove without physically modify existing components, thus reducing costs to a customer seeking to expand its business.

While the invention has been described with reference to its preferred embodiments, it will be understood by those skilled in the art that various changes may be made and equivalent may be substituted for elements thereof without departing from the true spirit and scope of the invention. In addition, many modifications may be made to adapt a particular situation or material to the teachings of the invention without departing from its essential teachings.

What is claimed is:

1. A manufacturing system having first and second components and a controller, the improvement comprising means for adding a first module to said system without substantial physical modifications to either first and second components.

2. The system of claim 1 wherein said first component comprises a laser and said second component comprises a shuttle system.

3. The system of claim 1 wherein communication cables are utilized to connect said first module to said controller.

4. The system of claim 1 wherein a wireless communication system connects said first module to said controller.

5. The system of claim 4 wherein a second module is connected to said controller.

6. The system of claim 5 wherein communication cables connect said second module to said controller.

7. The system of claim 5 wherein a wireless communication system connects said second module to said controller.
